(19) United States
(12) Patent Application Publication
(10) Pub. No.: US 2026/0309161 A1
(43) Pub. Date: Oct. 8, 2026

(54) IMPELLER WITH CONVERGING INDUCER

(71) Applicant: Pratt & Whitney Canada Corp., Longueuil (CA)

(72) Inventors: Patrick Harcourt, Streetsville (CA); Hien Duong, Mississauga (CA); Dave Menheere, Norval (CA)

(21) Appl. No.: 19/274,021

(22) Filed: Jul. 18, 2025

Related U.S. Application Data
(63) Continuation-in-part of application No. 19/170,159, filed on Apr. 4, 2025.

(51) Int. Cl. F04D 29/28; F04D 29/30

(52) U.S. Cl. CPC F04D 29/284; F04D 29/30; F05D 2220/323; F05D 2240/303; F05D 2240/304; F05D 2240/307

(57) ABSTRACT

Impeller assemblies for gas turbine engines include a hub configured to be rotated about an engine axis and a plurality of impeller blades extending radially outward from the hub, wherein each impeller blade comprises a leading edge, a trailing edge, a blade tip, and a blade inflection point defined on the blade tip between the leading edge and the trailing edge. Each impeller blade includes a radially inward tapering portion that extends from the leading edge of the respective impeller blade to the blade inflection point, wherein the radially inward direction is toward the engine axis and a radially outward tapering portion that extends from the inflection point to a trailing edge of the respective impeller blade, wherein the radially outward direction is away from the engine axis.

### CROSS-REFERENCE TO RELATED APPLICATIONS

This application is a Continuation-in-Part of U.S. application Ser. No. 19/170,159, filed Apr. 4, 2025, the disclosure of which is incorporated herein by reference in its entirety.

### BACKGROUND

Illustrative embodiments pertain to the art of gas turbine engines, and specifically to configurations and features of compressors of gas turbine engines.

Gas turbine engines are configured to combust fuel with air to generate a drive force for rotationally driving shafts and associated components to produce thrust for flight. Such engines typically include a fan, a compressor section, a combustor section, and a turbine section. Some engine configurations are designed with core flow and bypass flow paths, with a core flow directed through the compressor section for compression, combustion within the combustor section, and then expansion through the turbine section, prior to be exhausted from a nozzle of the engine. In some engine configurations, air may be extracted from compressor stages of the compressor section and supplied to other parts of the engine or to other aircraft systems for various purposes, such as cooling, lubrication, supplying air for humans on the aircraft, or the like. Such air that is extracted from the core flow of the engine may be referred to as bleed air. Bleed air may, for example, be used for temperature control, conditioning a fuel-air mixture in the combustor section, cooling of turbine section components of the engine, or the like. In some configurations, alternatively or in combination therewith, the bleed air may be circulated to the wings of the aircraft for ice control or to environmental control systems (e.g., for occupied parts of the aircraft, such as a cabin or cockpit). In some aircraft or engine configurations, the bleed air may be extracted and distributed for multiple purposes.

### BRIEF DESCRIPTION

According to some embodiments, impeller assemblies for gas turbine engines are provided. The impeller assemblies include a hub configured to be rotated about an engine axis and a plurality of impeller blades extending radially outward from the hub, wherein each impeller blade comprises a leading edge, a trailing edge, a blade tip, and a blade inflection point defined on the blade tip between the leading edge and the trailing edge. Each impeller blade comprises a radially inward tapering portion that extends from the leading edge of the respective impeller blade to the blade inflection point, wherein the radially inward direction is toward the engine axis, and a radially outward tapering portion that extends from the inflection point to a trailing edge of the respective impeller blade, wherein the radially outward direction is away from the engine axis.

In addition to one or more of the features described above, or as an alternative, further embodiments of the impeller assemblies may include that the radially outward tapering portion extends axially forward from the blade inflection point at an angle relative to the engine axis.

In addition to one or more of the features described above, or as an alternative, further embodiments of the impeller assemblies may include that the angle is between 1° and 30°.

In addition to one or more of the features described above, or as an alternative, further embodiments of the impeller assemblies may include that each impeller blade is defined by the radially inward tapering portion having an axial length Lᵢ defined from the leading edge to the blade inflection point along the blade tip and the blade tip has a blade axial length L_{b} from the leading edge to the trailing edge, and wherein

$$0.05 \leq \frac{{L}_{i}}{{L}_{b}} \leq 0.4 .$$

In addition to one or more of the features described above, or as an alternative, further embodiments of the impeller assemblies may include that the hub and plurality of impeller blades define a rotating component that is configured to compress and turn a flow passing therethrough from an axial direction at an inlet to the rotating component to a radial direction at an outlet of the rotating component.

In addition to one or more of the features described above, or as an alternative, further embodiments of the impeller assemblies may include that a radial position of the leading edge of the blade tip is at a radial position greater than the blade inflection point.

In addition to one or more of the features described above, or as an alternative, further embodiments of the impeller assemblies may include that each impeller blades is a split impeller blade comprising at least a first impeller blade section and a second impeller blade section.

In addition to one or more of the features described above, or as an alternative, further embodiments of the impeller assemblies may include a stator assembly positioned axially between the first impeller blade section and the second impeller blade section.

In addition to one or more of the features described above, or as an alternative, further embodiments of the impeller assemblies may include that the inflection point is defined at an axial position aligned with the stator assembly.

In addition to one or more of the features described above, or as an alternative, further embodiments of the impeller assemblies may include that the first impeller blade section and the second impeller blade section are arranged an axial spacing region defined between a trailing edge of the first impeller blade section and a leading edge of the second impeller blade section.

In addition to one or more of the features described above, or as an alternative, further embodiments of the impeller assemblies may include that the axial spacing region is defined by a negative value such that the trailing edge of the first impeller blade section is axially aft of the leading edge of the second impeller blade section and defining a section of axial overlap of the first and second impeller blade sections.

In addition to one or more of the features described above, or as an alternative, further embodiments of the impeller assemblies may include that the axial spacing region is defined by a positive value such that the trailing edge of the first impeller blade section is axially forward of the leading edge of the second impeller blade section and defining an axial gap between the first impeller blade section and the second impeller blade section.

In addition to one or more of the features described above, or as an alternative, further embodiments of the impeller assemblies may include that the first impeller blade section has a chord length (C) and the axial spacing region has a length (O), wherein the impeller assembly is defined by:

$$- 0.25 < \frac{O}{C} < 0.25 .$$

In addition to one or more of the features described above, or as an alternative, further embodiments of the impeller assemblies may include that each first impeller blade section of the plurality of impeller blades is separated from adjacent first impeller blade section in a circumferential direction by a blade spacing (P) and the first impeller blade section is spaced from the second impeller blade section in the circumferential direction by a separation gap(S), wherein the impeller assembly is defined by:

$$0.01 < \frac{S}{P} < 0.25 .$$

According to some embodiments, impeller assemblies for gas turbine engines are provided. The impeller assemblies include a rotating component comprising a plurality of impeller blades extending radially outward from a hub, wherein an axis is defined through the hub, wherein each impeller blade comprises a leading edge, a trailing edge, a blade tip, and a blade inflection point defined on the blade tip between the leading edge and the training edge. Each impeller blade comprises a radially inward tapering portion that extends from the leading edge of the respective impeller blade to the blade inflection point, wherein the radially inward direction is toward the engine axis, and a radially outward tapering portion that extends from the inflection point to a trailing edge of the respective impeller blade, wherein the radially outward direction is away from the engine axis. A split shroud is arranged about the rotating component and defining a flow path between an external surface of the hub and an internal surface of the split shroud, wherein the impeller blades are configured to be rotationally driven relative to the split shroud. The split shroud includes a first shroud element and a second shroud element configured to fixedly attach to the first shroud element. Each of the first shroud element and the second shroud element include a radially inward tapering portion that extends from a shroud leading edge of the respective shroud element to an inflection point, wherein the radially inward direction is toward the axis, and a radially outward tapering portion that extends from the inflection point to a shroud aft edge, wherein the radially outward direction is away from the axis.

In addition to one or more of the features described above, or as an alternative, further embodiments of the impeller assemblies may include an exducer shroud arranged aft of the split shroud, wherein a bleed slot is defined between a forward edge of the exducer shroud and the shroud aft edge.

In addition to one or more of the features described above, or as an alternative, further embodiments of the impeller assemblies may include that each impeller blades is a split impeller blade comprising at least a first impeller blade section and a second impeller blade section.

In addition to one or more of the features described above, or as an alternative, further embodiments of the impeller assemblies may include a stator assembly positioned axially between the first impeller blade section and the second impeller blade section.

In addition to one or more of the features described above, or as an alternative, further embodiments of the impeller assemblies may include that the stator assembly is attached to the split shroud.

In addition to one or more of the features described above, or as an alternative, further embodiments of the impeller assemblies may include a shroud support positioned about the split shroud and configured to secure the split shroud in place and to define a bleed air cavity between surfaces of the split shroud and the shroud support.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike: The subject matter is particularly pointed out and distinctly claimed at the conclusion of the specification. The foregoing and other features, and advantages of the present disclosure are apparent from the following detailed description taken in conjunction with the accompanying drawings in which like elements may be numbered alike and:

FIG. 1 is a schematic cross-sectional illustration of a gas turbine engine that may incorporate embodiments of the present disclosure;

FIG. 2 is a schematic illustration of a portion of a compressor section of a gas turbine engine that may incorporate embodiments of the present disclosure;

FIG. 3A is a cross-sectional view of an impeller assembly in accordance with an embodiment of the present disclosure;

FIG. 3B is a perspective illustration of the impeller assembly of FIG. 3A, as assembled;

FIG. 3C is a schematic illustration of the components of the impeller assembly of FIG. 3A;

FIG. 3D illustrates part of an installation process for assembling the impeller assembly of FIG. 3A;

FIG. 3E is a schematic illustration of a shroud element of the shroud assembly of FIG. 3A;

FIG. 4 is a schematic diagram of features of an impeller assembly in accordance with an embodiment of the present disclosure;

FIG. 5A is a cross-sectional view of an impeller assembly in accordance with an embodiment of the present disclosure that includes an integrated stator assembly;

FIG. 5B is a schematic illustration of components of the impeller assembly of FIG. 5A;

FIG. 5C is a schematic illustration of a shroud element of the impeller assembly of FIG. 5A;

FIG. 6 is a flow process for assembling an impeller assembly in accordance with an embodiment of the present disclosure;

FIG. 7 is a schematic illustration of an impeller assembly having impeller blades with blade inflection points in accordance with an embodiment of the present disclosure;

FIG. 8A is a schematic illustration of a split impeller blade configuration in accordance with an embodiment of the present disclosure; and

FIG. 8B is an alternative view of the split impeller blade configuration of FIG. 8A.

### DETAILED DESCRIPTION

Detailed descriptions of one or more embodiments of the disclosed apparatus and/or methods are presented herein by way of exemplification and not limitation with reference to the Figures.

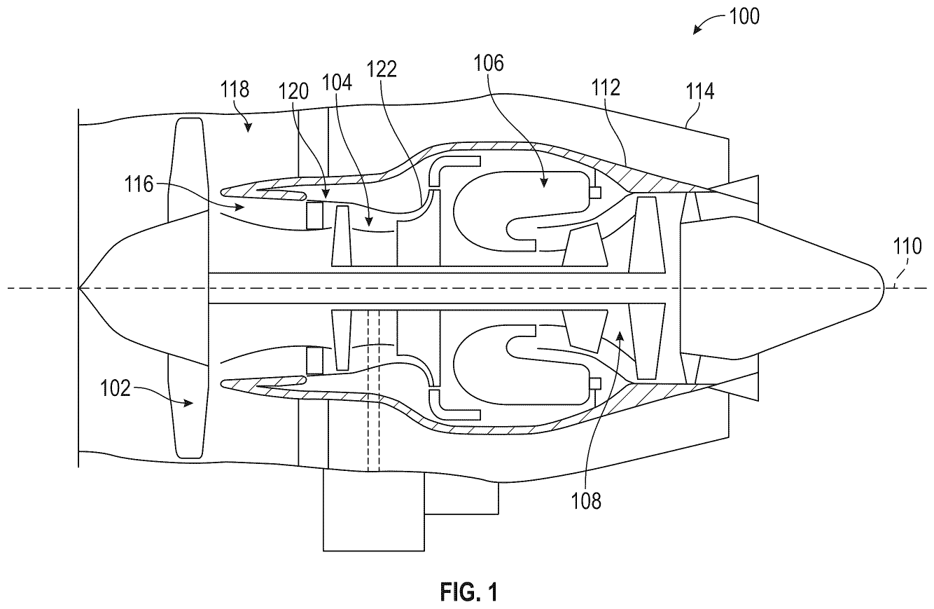

FIG. 1 is a schematic illustration of a gas turbine engine 100 that may incorporate embodiments of the present disclosure. The gas turbine engine 100 includes, arranged in serial flow communication, a fan section 102 through which ambient air is propelled, a compressor section 104 for pressurizing the air, a combustor section 106 in which the compressed air is mixed with fuel and ignited for generating a stream of hot combustion gases, and a turbine section 108 for extracting energy from the combustion gases. The sections 102, 104, 106, 108 may be axially arranged along an engine axis 110 and arranged within an engine housing 112 which in turn is arranged within an engine nacelle 114. The gas turbine engine 100 defines a core flow path 116 directed from the fan section 102 and into the engine housing 112 through the compressor section 104, the combustor section 106, and the turbine section 108. A bypass flow path 118 is defined between the engine housing 112 and the engine nacelle 114.

The gas turbine engine 100 may be mounted on an aircraft, such as on a wing, fuselage, tail, or the like. The gas turbine engine 100 is configured to generate and provide propulsion to the aircraft. In addition to generating thrust and propulsive force, the gas turbine engine 100 may be configured to implement additional functions. For example, the gas turbine engine 100 may be configured to generate and provide a supply of pressurized air, which may be referred to as bleed air, to other aircraft systems. The other aircraft systems may be parts of the gas turbine engine 100 or may be parts or systems of the aircraft. The bleed air may be drawn from the compressor section 104 and supplied to various systems through a bleed duct 120. The bleed air may be, for example, used for cooling parts of the combustor section 106 and/or the turbine section 108. In some arrangements, the bleed air may be employed as a heat source, for example, for cabin environmental controls, anti-icing systems or the like. It will be appreciated that the bleed air may be extracted and directed to various onboard systems for various heating, cooling, and/or pressurizing purposes. The bleed air may be extracted from the compressor section 104, and more particularly, may be extracted from an impeller 122 of the compressor section 104. The impeller 122, as illustrated, is a centrifugal compressor that is arranged to turn an axial flow of the core flow through the core flow path 116 to a radial flow prior to mixing with fuel for combustion within the combustor section 106.

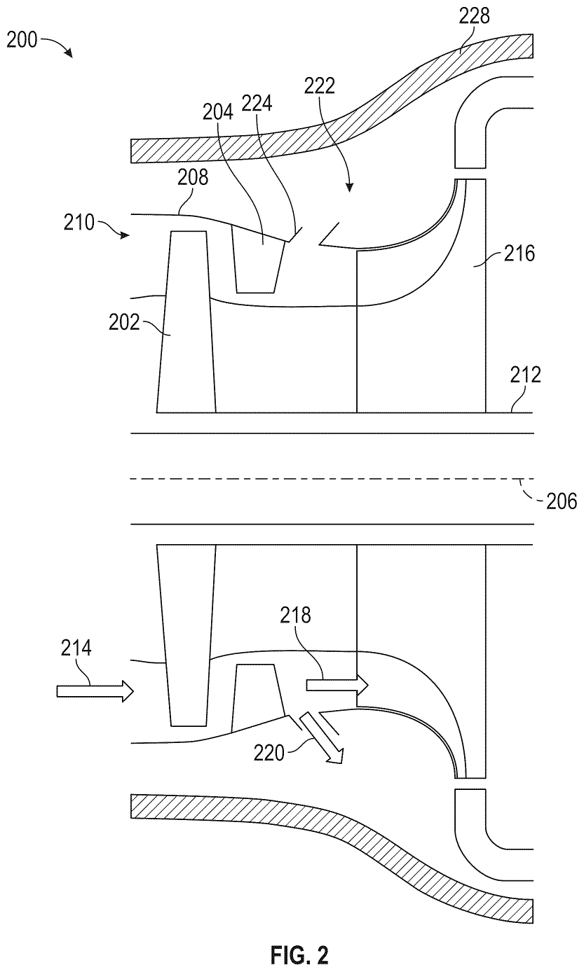

Referring now to FIG. 2, a schematic illustration of a portion of a compressor section 200 of a gas turbine engine that may incorporate embodiments of the present disclosure is shown. The compressor section 200 includes one or more rotor(s) 202 and stator(s) 204 which are axially arranged along or relative to an engine axis 206. In the illustrative portion shown in FIG. 2, a single rotor 202 and a single downstream stator 204 is illustrated in an axial direction. However, it will be appreciated that multiple rotors and stators may be arranged serially along the compressor section 200 (e.g., multiple stages) in the axial direction. The rotor 202 and the stator 204 are arranged within a casing 208, which defines a portion of a core flow path 210. Each rotor 202 is mounted for rotation on an engine shaft 212 and each stator 204 is stationary relative to the rotor 202 and may be fixedly attached to or part of the casing 208. A core flow air 214 may be provided from an upstream section of the compressor section 200 or from a fan section, as described above. The core flow air 214 is compressed as it passes through the rotors 202 and stators 204 of the compressor section 200.

Each rotor 202 and each stator 204 is configured with a plurality of airfoil members (e.g., rotor blades and stator vanes) distributed around a circumference of the respective structure and about the engine axis 206. Each of the airfoil members is arranged to extend into the core flow path 210 to interact with a core flow therethrough. The rotor blades of the rotors 202 may be attached, affixed, or otherwise mounted on rotor disks or may be integrally formed with respective rotor disk(s) (e.g., integrally bladed rotor). The stator vanes may be arranged as stator assemblies that are mounted to the casing 208 or integrally formed therewith. The stator vanes of the stator 204 and the rotor blades of the rotors 202 are configured so that rotation of the rotors 202 draws the core flow air 214 from an upstream location (e.g., a fan section) and forces the core flow air 214 along the core flow path 210 (e.g., an annular passage). Rotation of rotor(s) 202 will accelerate the core flow air 214 and increase the dynamic pressure and temperature thereof.

Downstream from the rotor(s) 202 and stator(s) 204 is an impeller 216. The impeller 216 is configured to receive and further compress, turn, and accelerate a combustor portion 218 of the core flow air 214 which is directed into a combustor section for combustion with fuel, as will be appreciated by those of skill in the art. As noted above, a portion of the core flow air 214 may be extracted as bleed air 220 into a bleed air cavity 222 (e.g., part of or fluidly connected to a bleed duct). The bleed air 220 is extracted or bled from the core flow air 214 in the core flow path 210 through one or more bleed apertures 224 and dumped into the bleed air cavity 222. As the bleed air 220 passes into the bleed air cavity 222, the bleed air 220 is decelerated and kinetic energy is recovered as static pressure. The bleed apertures 224 may be spaced circumferentially around the casing 208 and are located, in this illustrated configuration, immediately upstream from an inlet or upstream end of the impeller 216. As such, in this configuration, the bleed air 220 may be extracted at a location downstream of the last set or state of vanes of the stator(s) 204. It will be appreciated that bleed apertures 224 may be located at various other locations where bleed may be required, including, but not limited to, completely or partially between stator vanes rotor blades or at a location on the impeller 216.

Engine efficiencies may be impacted, in part, by the amount of air flow passed through the engine. Conventional engine configurations typically employ an impeller configuration that has a substantially constant radial dimension along the inlet, particularly at the radially outer diameter of the impeller. Such a constant radial dimension results in a limitation on the amount of air that can be directed into the impeller. However, by increasing the amount of airflow entering the impeller, engine efficiency can be increased. Accordingly, in accordance with some embodiments of the present disclosure, the cross-sectional area at the inlet of an impeller is increased compared to such prior configurations.

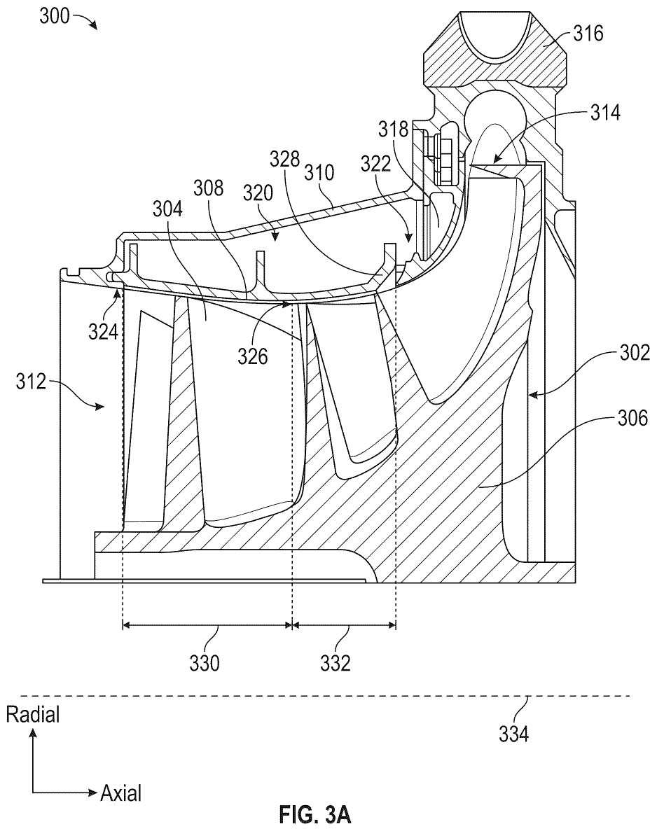

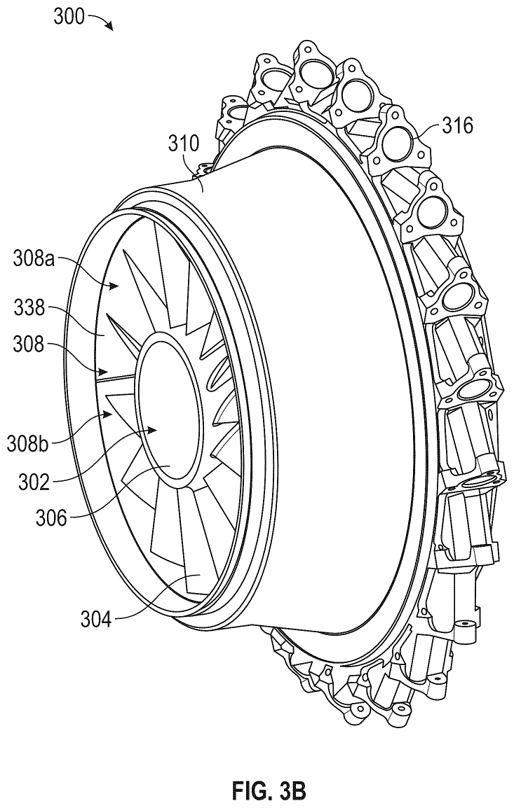

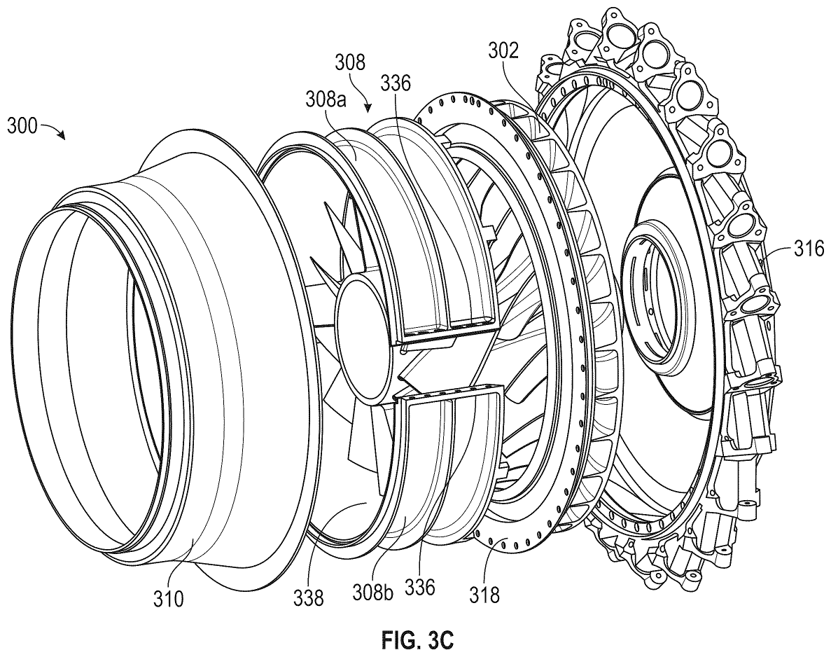

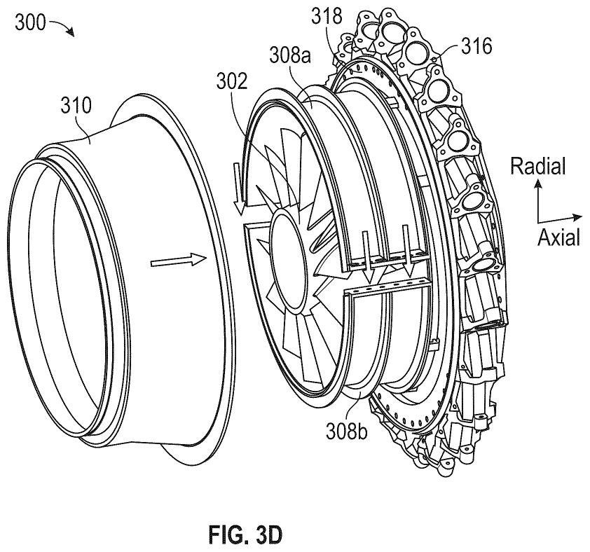

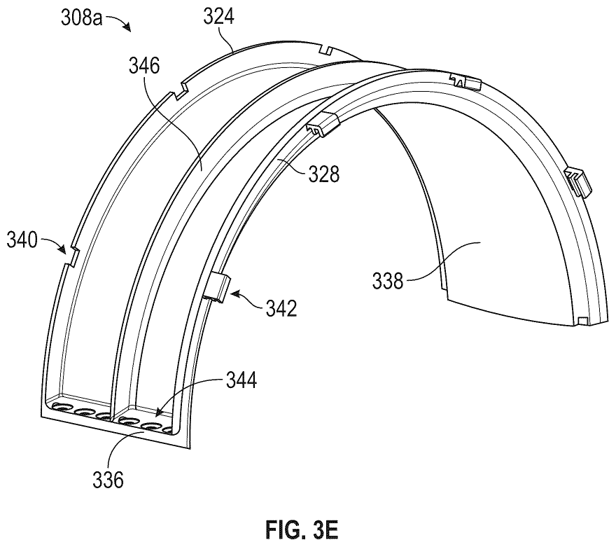

Referring now to FIGS. 3A-3E, schematic illustrations of an impeller assembly 300 in accordance with an embodiment of the present disclosure are shown. The impeller assembly 300 includes a rotating component 302 having a number of impeller blades 304 extending from a hub 306. The rotating component 302 is arranged within a split shroud 308 such that the impeller blades 304 may be rotated relative to the split shroud 308. The split shroud 308 is supported within a shroud support 310. The impeller assembly 300 defines a flow path from an inlet 312 to an outlet 314. It will be appreciated that the inlet 312 may be fluidly coupled to an upstream compressor and/or fan assembly of an engine, such as shown and described above. The outlet 314 may be fluidly coupled to an outlet assembly 316, which may be arranged to direct compressed air from the impeller assembly 300 into a combustor section of the engine.

At the aft end of the split shroud 308 is an exducer shroud 318. The flow path through the impeller assembly 300 is defined between surfaces of the hub 306, at the root of the impeller blades 304, and inner surfaces of the split shroud 308 and the exducer shroud 318. The impeller assembly 300 is configured to turn a flow of air from an axial direction at the inlet 312 to a radial direction at the outlet 314. The impeller assembly 300 is configured to receive air from a fan section or upstream compressor section, and compress or further compress the air and turn it from an axial flow to a radial flow through the flow path defined through the impeller assembly 300. The split shroud 308 and the exducer shroud 318 are arranged radially inward from the shroud support 310. A bleed air cavity 320 is defined between an inner surface of the shroud support 310 and surfaces of the split shroud 308 and the exducer shroud 318. A bleed slot 322 is defined between an aft end of the split shroud 308 and a forward end of the exducer shroud 318. The bleed slot 322 is arranged to extract a portion of the airflow through the impeller assembly 300 and direct such extracted air into the bleed air cavity 320. The bleed air may be distributed and/or used at other locations on the engine or aircraft, as discussed above.

The impeller assembly 300 of this illustrative embodiment is configured to provide a larger volume or throughflow of air from upstream systems (e.g., fan section and/or upstream compressor section), without substantially impacting the outlet end, thus resulting in a greater amount of air passing into the combustor section from the compressor section, and thereby achieving greater efficiencies in the overall engine operation. Due to, for example, manufacturing and assembly constraints, impeller assemblies typically align with an upstream system (e.g., compressor), the impeller is typically configured with a cylindrical outer diameter. Such a configuration can limit the amount of air that can be directed into and through the impeller assembly. In view of this, and other considerations, the impeller assembly 300, shown in FIGS. 3A-3E, for example, is arranged with an increased inlet area to permit a larger volume of air to be directed into the impeller assembly 300.

The split shroud 308 is formed from two, or more, shroud elements that are joined together about the rotating component 302. For example, as shown in FIGS. 3A-3E, the split shroud 308 is formed of two shroud elements 308a, 308b. As shown in FIGS. 3C-3D, for example, the rotating component 302 may be arranged between the outlet assembly 316 and the exducer shroud 318. The outlet assembly 316 and the exducer shroud 318 are stationary components that may be statically fixed to an engine casing or other static engine structure. The rotating component 302 may be affixed or mounted or otherwise rotationally coupled to an engine shaft, as will be appreciated by those of skill in the art. The exducer shroud 318 may be mounted to the outlet assembly 316 to define the outlet 314 of the impeller assembly 300. The shroud elements 308a, 308b may then be assembled about the rotating component 302 to form the split shroud 308. When assembled, the bleed slot 322 will be defined between the split shroud 308 and the exducer shroud 318. The shroud support 310 may be installed about the split shroud 308 and affixed to the exducer shroud 318 and/or the outlet assembly 316, thereby defining the bleed cavity 320 and fixedly capturing the split shroud 308 within the shroud support 310. In some configurations, and as shown in FIG. 3A, the shroud support 310 may engage with a leading or forward end of the split shroud 308 at a shroud leading edge 324. The shroud leading edge 324 may include a coupling mechanism (e.g., interference fit, fasteners, etc.) and/or one or more seals to prevent gas flow through the connection between the shroud leading edge 324 and the shroud support 310.

The split shroud 308 is provided with a conical and radially inward tapering portion that extends from the inlet 312 of the impeller assembly 300 to an inflection point 326. That is, the radial dimension of the split shroud 308 tapers radially inward from the shroud leading edge 324 at the inlet 312 to the inflection point 326. Aft of the inflection point 326, the split impeller 308 may extend aftward at a constant radial position (e.g., defining a substantially cylindrical section) or may transition to a radial outward tapering or curvature. Aft of the inflection point 326, the split shroud 308 will curve radially outward to turn the flow path radially outward to the outlet 314. The split shroud 308 thus extends aft from the inflection point 326 to the bleed slot 322, which is defined between a shroud aft edge 328 of the split shroud 308 and the exducer shroud 318.

The split shroud 308 thus defines a radially inward tapering portion 330 and a radially outward tapering portion 332. The radially inward tapering portion 330 extends, in an axial direction, from the shroud leading edge 324 to the inflection point 326. The radially outward tapering portion 332 extends, in the axial direction, from the inflection point 326 to the shroud aft edge 328 of the split shroud 308. Aft of the shroud aft edge 328 of the split shroud 308 is the exducer shroud 318, separated by the bleed slot 322, which defines the final turning of the flow path from the axial direction to the radial direction at the outlet 314 of the impeller assembly 300.

The radial positions of the split shroud 308 may be defined relative to an engine axis 334. Because of the tapering arrangement of the split shroud 308, the shroud leading edge 324 is positioned at a radial position that is greater than a radial position of the inflection point 326. Similarly, the shroud aft edge 328 of the split shroud 308 is at a radial position that is equal to or greater than the radial position of the inflection point 326. Because of the tapering geometry of the split shroud 308, conventional installation techniques are not possible. For example, using a conventional shroud assembly, the shroud is axial slid over the rotating component. However, because the tapering of the split shroud reduces in the radial dimension from the shroud leading edge 324 to the inflection point 326 and then tapers radially outward, a sliding installation is not possible. Rather, the split shroud 308 is separated into the shroud elements 308a, 308b which may be joined at joining flanges 336, as shown in FIG. 3C. Fasteners or other mechanical connectors may be used to join the joining flanges 336 to assemble the split shroud 308 as a complete structure about the rotating component 302. As shown in FIG. 3D, the shroud elements 308a, 308b are installed radially, not axially, and then the shroud support 310 may be installed axially about the split shroud 308.

The split shroud 308 is arranged about the rotating component 302 to define the flow path through the impeller assembly 300. Because the impeller blades 304 are rotationally driven within and relative to the inner surface of the split shroud 308, the split shroud 308 may include an abradable surface 338 on the radially inner surfaces of the shroud elements 308a, 308b. FIG. 3E illustrates the shroud element 308a in isolation to illustrate features thereof, with the second shroud element 308b being substantially the same. The shroud element 308a, as shown in FIG. 3E, includes the abradable surface 338 on the inner surface thereof. At the shroud leading edge 324 of each shroud element 308a, 308b, may be one or more anti-rotation features 340. The anti-rotation features 340 may be configured to engage with a complimentary element of the shroud support 310 and/or another fixed or static structure of the engine system. At the shroud aft edge 328, each shroud element 308a, 308b may include one or more axial locating features 342. The axial locating features 342 may be provided to engage with or provide guidance for installing the respective shroud elements 308a, 308b to the exducer shroud 318. FIG. 3E also illustrates the joining flanges 336 having flange apertures 344 for receiving fasteners or the like to fixedly connect the shroud elements 308a, 308b together. As shown, the shroud elements 308a, 308b may include support ribs 346 to provide additional structural rigidity to the respective shroud elements 308a, 308b and to the formed split shroud 308.

As noted above, an intent of embodiments of the present disclosure is to increase the inlet cross-sectional area of the impeller assembly to thereby provide an increased or larger inlet, as compared to conventional systems, while minimizing cross-sectional changes to the system as a whole. In accordance with embodiments of the present disclosure, the split shroud of the impeller allows for a larger inlet area while maintaining a knee to exducer radius ratio to improve performance while minimizing cross-sectional changes. For example, the shroud leading edge, and associated tip radius of the impeller blades, is larger than at the knee and allows larger flows to the impeller assembly. Previous designs required the inducer to be the same radius (or smaller) than the knee to enable assembly.

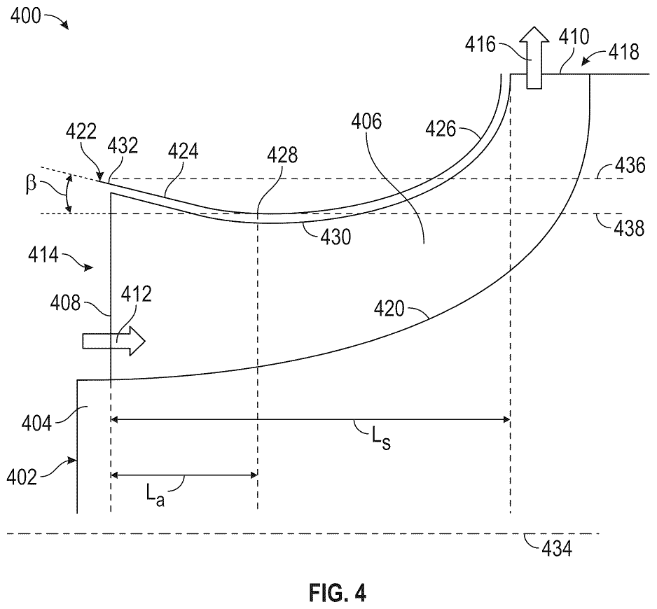

Referring now to FIG. 4, a schematic diagram of an impeller assembly 400 in accordance with an embodiment of the present disclosure is shown. The impeller assembly 400 may be similar to that shown and described above with respect to FIGS. 3A-3E. The impeller assembly 400 includes a rotating component 402 having a hub 404 and impeller blades 406 extending therefrom. The impeller blades 406 extend from a leading edge 408 to a trailing edge 410 along an arcuate or curve path such that an airflow changes from an axial flow 412 at an inlet 414 of the impeller assembly 400 to a radial flow 416 at an outlet 418 of the impeller assembly 400.

The flow path of the impeller assembly 400 is defined by a surface 420 of the hub 404 and a surface of a split shroud 422, as shown and described above. The impeller blades 406 are arranged to be rotationally driven within the space between the hub 402 and the split shroud 422 to drive, compress, and turn a flow of air passing through the impeller assembly 400.

As shown in FIG. 4, the split shroud 422 is arcuate with a radially inward tapering portion 424 and a radially outward tapering portion 426 arranged about an inflection point 428. The impeller blades 406 will have a similarly shaped blade tip 430 that is parallel with and complimentary with the arcuate surface and shape of the split shroud 422. Although a gap may exist between the blade tip 430 and the split shroud 422, the split shroud 422 may include an abradable surface to accommodate contact between the blade tip 430 and the surface of the split shroud 422. The inflection point 428 defines the smallest radial position of the split shroud 422.

The split shroud 422 extends from a shroud leading edge 432 at the inlet 414 of the impeller assembly 400 and tapers radially inward to the inflection point 428 along the radially inward tapering portion 424. Axially aft of the inflection point 428, the radially outward tapering portion 426 extends from the inflection point 428 to the outlet 418 of the impeller assembly 400. The impeller assembly 400 is a circumferential structure that is substantially circular and arranged about an engine axis 434. The shroud leading edge 432, radially outward from a tip of the impeller blade 406 at the leading edge 408 thereof, has a leading-edge radial position 436 relative to the engine axis 434. The split shroud 422 extends axially aft and radially inward from the shroud leading edge 432 at the leading-edge radial position 436 to the inflection point 428. The inflection point 428 has an inflection point radial position 438 relative to the engine axis 434. The leading-edge radial position 436 is greater than the inflection point radial position 438, which is due to the tapering or narrowing shape of the split shroud 422. Axially aft of the inflection point 428, the split shroud 422 will expand or taper outward to follow the contour of the rotating component 404 and define the turning flow path of the impeller assembly 400.

As shown in FIG. 4, the radially inward tapering portion 424 is angled relative to the engine axis 434 (and lines parallel thereto) at an angle β. The angle β defines the angle of radial inward tapering of the contour of the split shroud 422. The angle β may be defined by the following bounds: 1 deg≤β≤30 deg.

The radially inward tapering portion 424 has a forward axial length Lₐ, relative to the engine axis 434. That is, the axial length of the split shroud 422 from the shroud leading edge 432 to the inflection point 428 is defined by the forward axial length Lₐ. The total axial length of the split shroud 422, extending from the shroud leading edge 432 to the outlet 418 of the impeller assembly 400, and aligned with the trailing edge 410 of the impeller blade 406, is defined as shroud axial length Lₛ. In accordance with some embodiments of the present disclosure, the impeller assembly 400 may be defined by the following relationship:

$$0.05 \leq \frac{{L}_{a}}{{L}_{s}} \leq 0.4 .$$

In the impeller assembly 300 and the impeller assembly 400, the impeller blades extend continuously from the inlet to the outlet of the respective impeller assemblies. In accordance with some embodiments, the impeller blades may be discontinuous. In such configurations, the impeller shroud, and specifically the split shroud may be provided with an integrated stator. Inclusion of such a stator can allow an improvement in efficiency and pressure ratio while minimizing axial length increases.

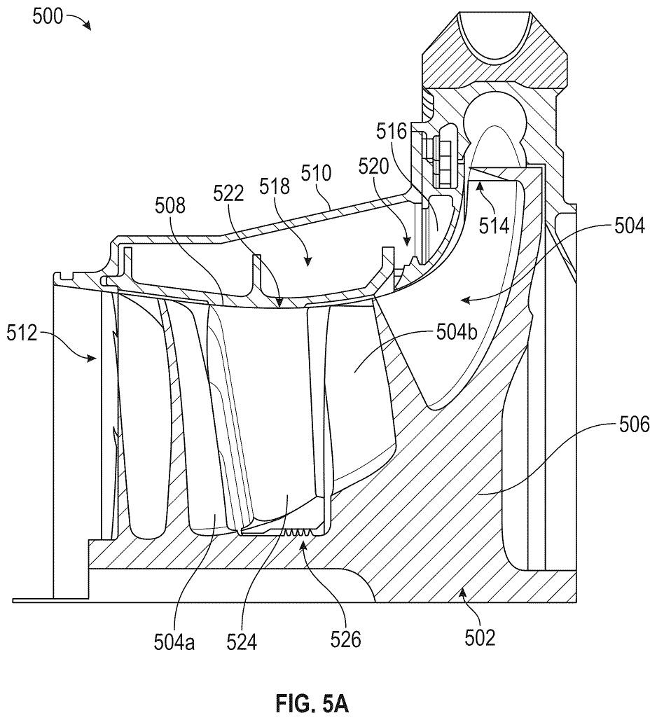

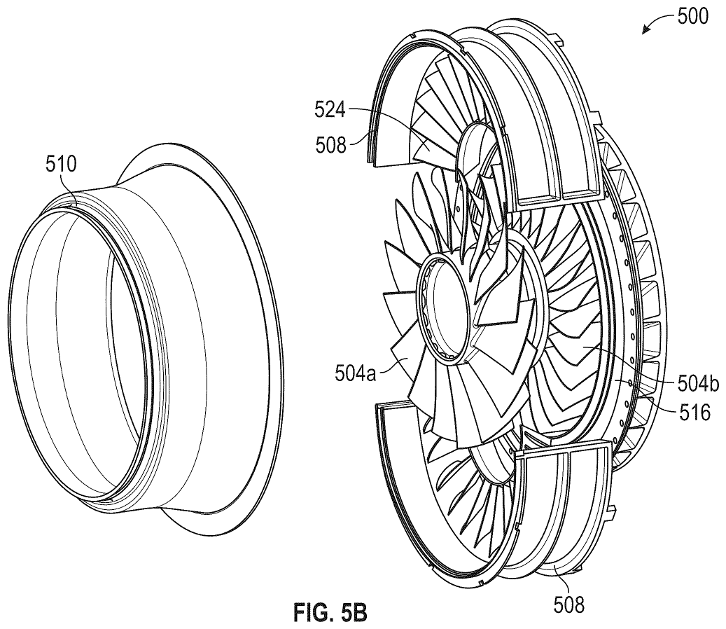

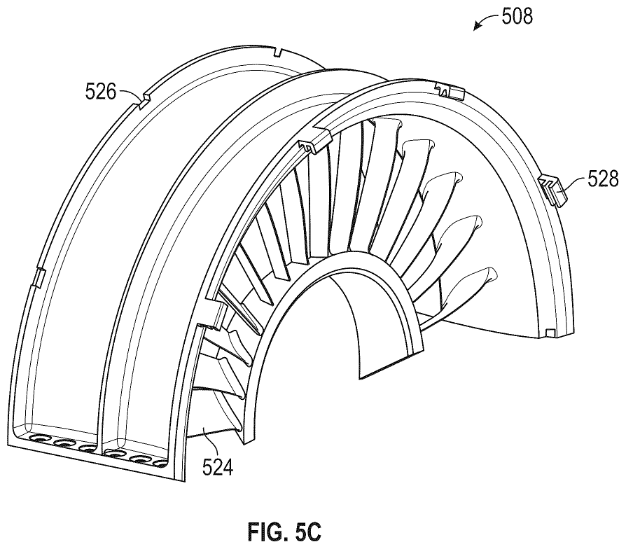

For example, referring now to FIGS. 5A-5C, schematic illustrations of an impeller assembly 500 in accordance with an embodiment of the present disclosure are shown. The impeller assembly 500 may be similar to that shown and described. In this illustrative configuration, the impeller assembly 500 includes a rotating component 502 having a number of split impeller blades 504 (divided into impeller blade sections 504a, 504b) extending from a hub 506. The rotating component 502 is arranged within a split shroud 508 such that the impeller blades 504 may be rotated relative to the split shroud 508, as shown and described above. The split shroud 508 is supported within a shroud support 510. The impeller assembly 500 defines a flow path from an inlet 512 to an outlet 514.

At the aft end of the split shroud 508 is an exducer shroud 516. The flow path through the impeller assembly 500 is defined between surfaces of the hub 506, at the root of the impeller blades 504, and inner surfaces of the split shroud 508 and the exducer shroud 516. The impeller assembly 500 is configured to turn a flow of air from an axial direction at the inlet 512 to a radial direction at the outlet 514. The split shroud 508 and the exducer shroud 516 are arranged radially inward from the shroud support 510. A bleed air cavity 518 is defined between an inner surface of the shroud support 510 and surfaces of the split shroud 508 and the exducer shroud 516. A bleed slot 520 is defined between an aft end of the split shroud 508 and a forward end of the exducer shroud 516.

The split shroud 508 is arranged with a tapering contour or geometry that includes an inflection point 522, similar to that shown and described above. The forward end or portion of the split shroud 508 is defined by a radially inward tapering portion that extends to the inflection point 522 and aft of the inflection point 522 a radially outward tapering portion extends aftward.

In this illustrative configuration, the split shroud 508 includes a stator assembly 524. The stator assembly 524 is a static component that is fixedly connected to or integrally formed with the split shroud 508. Due to the nature of the split shroud 508, each half, in this illustrative configuration, includes a respective part of the stator assembly 524, as shown in FIGS. 5B-5C. The stator assembly 524 includes a number of stator blades that are angled to turn and direct airflow as it is directed and passed through the impeller assembly 500. In this illustrative configuration, the inflection point 522 is located within the axial span of the stator assembly 524. Because the rotating component 502 is configured to rotate relative to the stationary/static components, a seal 526 (e.g., brush seal, knife seal, etc.) may be arranged between a radially inward part of the stator assembly 524 and a surface of the rotating component 502.

As shown in FIGS. 5A-5B, the impeller blades 504 are separated or divided in the axial direction into a forward impeller blade section 504a and an aft impeller blade section 504b, with the stator assembly 524 arranged therebetween. The impeller blade sections 504a, 504b may be arranged as substantially continuous structures, with a central part thereof removed to accommodate the installation of the stator assembly 524 between the impeller blade sections 504a, 504b. As shown in FIG. 5C, the split shroud 508 (one part shown) includes anti-rotation features 526 and axial locating features 528, similar to that shown and described above.

Although shown with the inflection point 522 at a position that is axially aligned with the stator assembly 524 (e.g., between the leading and trailing edges of the vanes of the stator assembly in the axial direction), such position is not intended to be limiting. For example, the inflection point of embodiments of the present disclosure may be at or axially proximate the trailing edge of the forward impeller blade section 504a, but upstream or forward of the stator assembly 524. In other configurations, the inflection point may be axially aligned with or proximate to the leading edge of the aft impeller blade section 504b. Furthermore, it will be appreciated that the axial location of the inflection point, when aligned with the stator assembly 524, may be at any axial position between the leading edge or forward axial position of the stator assembly 524 and the trailing edge or aft axial position of the stator assembly 524, without departing from the scope of the present disclosure (inclusive of the leading and trailing edge axial locations).

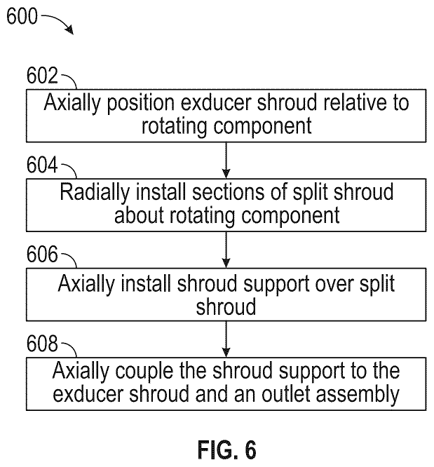

Referring now to FIG. 6, a flow process 600 for assembling an impeller assembly in accordance with an embodiment of the present disclosure is shown. The flow 600 may be followed to assembly the impeller assemblies shown and described above. In particularly, the flow process 600 is described to be used with a split shroud that is installed about a rotating component. The split shroud has a narrowing or tapering shape/contour such that the radial dimensions of the split shroud decrease in the axial direction from a shroud leading edge to an inflection point, after which the split shroud extends axially or radially outward.

At block 602, an exducer shroud is installed relative to a rotating component of the impeller assembly. The installation of the exducer shroud is along the engine axis or axially installed. The exducer shroud may be positioned initially without support or may be fixedly attached to an outlet assembly or the like.

At block 604, with the exducer shroud in place, sections of a split shroud are installed radially to the exducer shroud and about the impeller blades of the rotating component. The impeller blades of the rotating component may have a radially increasing dimension toward the leading edge, which increases the inlet area of the impeller assembly. To accommodate the radially increasing dimension of the impeller blades, the split shroud has a contoured shape having an inflection point between forward/leading edge/ends and aft/trailing edge/ends of the split shroud. In configurations with an integral stator assembly (e.g., shown in FIGS. 5A-5C), the stator assembly may be installed in a radial direction between impeller blade sections, as shown and described above. The stator assembly, in such installation processes, may include engaging a radially inward platform of the stator assembly with a seal that is arranged between such stator platform and a surface of the rotating component.

The sections of the split shroud may be joined or coupled together. For example, fasteners may be used to bolt or otherwise attach the various sections of the split shroud. When installing the split shroud, a bleed slot will be defined between an aft end of the split shroud and the exducer shroud, to allow for bleed air to pass between the two shrouds during operation.

At block 606, a shroud support is installed axially about the split shroud. The shroud support encloses the split shroud within the shroud support. When installed, a bleed air cavity will be defined between surfaces of the shroud support, the split shroud, and the exducer shroud. The bleed air cavity may be fluidly coupled to a flow path defined by and between the impeller blades of the rotating component. The bleed air cavity may also be fluidly coupled to other systems to provide the bleed air from the bleed air cavity to such other systems, as will be appreciated by those of skill in the art.

At block 608, the shroud support may be sealingly engaged with or otherwise coupled to a forward end of the split shroud in the axial direction. At the aft end of the shroud support, the shroud support may be attached to the exducer shroud and/or an outlet assembly, in the axial direction. The result is a fixed, stationary, or static assembly, with a rotating component captured within.

The assembled impeller assembly provides for an increased amount of airflow into and through the impeller assembly due to an increased radial size of the inlet. This is achieved by a forward portion or end of the impeller shroud to extend radially outward from an inflection point. As a result, as compared to a conventional impeller system, the amount of airflow may be increased by 5% to 30%, which in turn can result in improved efficiencies of the combustor section and the engine operations as a whole.

Although shown herein with two sections of the split shroud, it will be appreciated that any number of sections may be employed, without departing from the scope of the present disclosure. For example, the split shrouds of the present disclosure may be assembled from two, three, four, or more sections that are joined together about a rotating component. The sections of the split shrouds will be installed radially, rather than axially, allowing for the tapering geometry that results in the inflection point along the contour of the impeller shroud.

In accordance with embodiments of the present disclosure, the impeller blades of the impellers may be configured to follow the contour of the impeller shrouds shown and described above. To enhance the power of aircraft engines, utilizing a compressor with a front-stage impeller design often necessitates increasing the inducer frontal area to accommodate greater mass flow and/or speed. By employing a split shroud design as shown and described above, it becomes feasible to expand the impeller frontal area by elevating the inducer tip radius, followed by a converging section leading to the knee, while preserving a similar exducer design. In accordance with embodiments of the present disclosure, to increase the frontal area of the impeller for higher mass flow and power, either or both the inducer hub and shroud radii can be adjusted—lowered or raised, respectively. However, the hub radius often cannot be reduced due to limitations imposed by bearing and shaft size constraints. This constraint means that increasing the inducer tip radius becomes mechanism for increasing the frontal area of the impeller. In accordance with embodiments of the present disclosure, a split shroud design allows for impeller blade configurations in which a knee area can be maintained at a lower radius.

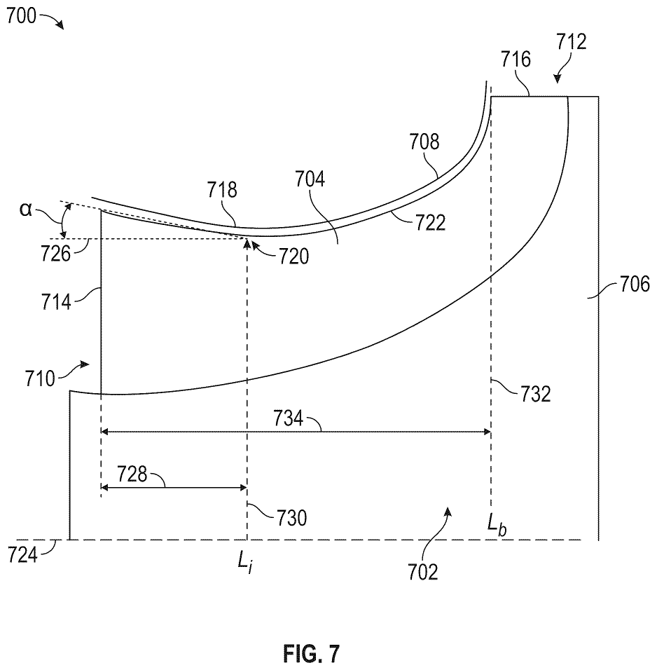

Referring now to FIG. 7, a schematic illustration of an impeller assembly 700 in accordance with an embodiment of the present disclosure is shown. The impeller assembly 700 may be similar to that shown and described. In this illustrative configuration, the impeller assembly 700 includes a rotating component 702 having a number of impeller blades 704 extending from a hub 706. The rotating component 702 is arranged within a shroud 708 (e.g., a split shroud as shown and described above) such that the impeller blades 704 may be rotated relative to the shroud 708, as shown and described above. The shroud 708 is supported within a shroud support (not shown), as described above. The impeller assembly 700 defines a flow path from an impeller inlet 710 to an impeller outlet 712. The impeller blades 704 includes a leading edge 714 at the impeller inlet 710 and a trailing edge 716 at the impeller outlet 712.

A flow path through the impeller assembly 700 is defined between surfaces of the hub 706, at the root of the impeller blades 704, and inner surfaces of the shroud 708. The impeller assembly 700 is configured to turn a flow of air from an axial direction at the impeller inlet 710 to a radial direction at the impeller outlet 712. A bleed slot (not shown) may be provided as shown and described above. The shroud 708 is arranged with a tapering contour or geometry that includes an inflection point 718, similar to that shown and described above. The forward end or portion of the shroud 708 is defined by a radially inward tapering portion that extends to the inflection point 718 and aft of the inflection point 718 a radially outward tapering portion extends aftward.

The impeller blades 704 have a similar geometry and/or contour as that of the shroud 708. That is, the impeller blades 702 includes a blade inflection point 720 that is located at a position along the length of the impeller blades 702 between the leading edge 714 and the trailing edge 716 thereof. The blade inflection point 720 is defined on a blade tip 722. In a forward direction from the blade inflection point 720, the blade tip 722 extends radially outward, resulting in the blade tip 722 at leading edge 714 being radially outward from the blade inflection point. The blade tip 722 extends forward from the blade inflection point 720 at an angle relative to an engine axis 724. For example, as shown in FIG. 7, the blade tip 722 is angled at a blade tip angle α relative to the engine axis 724 (or a parallel line 726 that is parallel with the engine axis 724 and passing through the blade inflection point 720). The blade tip angle α may be a positive angle in the forward direction from the blade inflection point 720. In accordance with some embodiments, and without limitation, the blade tip angle α may be defined between 1° and 30° relative to the engine axis 724 (1 deg≤β≤30 deg). It will be appreciated that other angles outside this range may be employed without departing from the scope of the present disclosure, such as any angle greater than 0° relative to the engine axis 724. The angle α defines the angle of radial inward tapering of the contour of the blade tip 722 from the leading edge 714 to the blade inflection point 720.

The radially inward tapering portion of the blade tip 722 has an axial length 728, relative to the engine axis 724, and extending axially from the leading edge 714 to the axial position 730 of the blade inflection point 720 (Lᵢ). That is, the axial length of the impeller blade 704 from the leading edge 714 to the blade inflection point 720 is defined by the axial length 728. The total axial length of the blade tip 722, extending from the leading edge 714 to an axial position 732 of the trailing edge 716 of the impeller blade 704 is defined as a blade axial length 734 (L_{b}). In accordance with some embodiments of the present disclosure, the impeller blade 704 may be defined by the following relationship:

$$0.05 \leq \frac{{L}_{i}}{{L}_{b}} \leq 0.4 .$$

As shown, the impeller assembly 700 includes an impeller blade 704 with a blade tip 722 that extends to a greater radial position than the blade inflection point 720. The relatively large radial dimension of the leading edge 714 of the impeller blade 704 allows for a wider impeller inlet 710. Such wider impeller inlet 710 enables for more massflow compared to non-tapering blade configurations. Such increased massflow can result in improved engine efficiencies.

In the embodiment shown in FIG. 7, the impeller blade 704 is a single, continuous blade that extends from the leading edge 714 at the impeller inlet 710 to the trailing edge 716 at the impeller outlet 712. Such configuration is merely illustrative, and embodiments of the present disclosure are not intended to be limited to such impeller blade design. For example, in some embodiments, the impeller blades may be split into forward and aft portions that are split by a stator assembly into impeller blade sections (e.g., as shown in FIGS. 5A-5B). The stator assembly may extend radially inward from the shroud with a forward impeller blade section arranged forward of the stator assembly and an aft impeller blade section arranged aft of the stator assembly. In some such embodiments, the forward impeller blade section will define a radially outward tapering, such as shown and described above. Such split impeller blade configuration, as shown in FIGS. 5A-5B, is not intended to be limiting, but rather is one example of a modified impeller blade configuration.

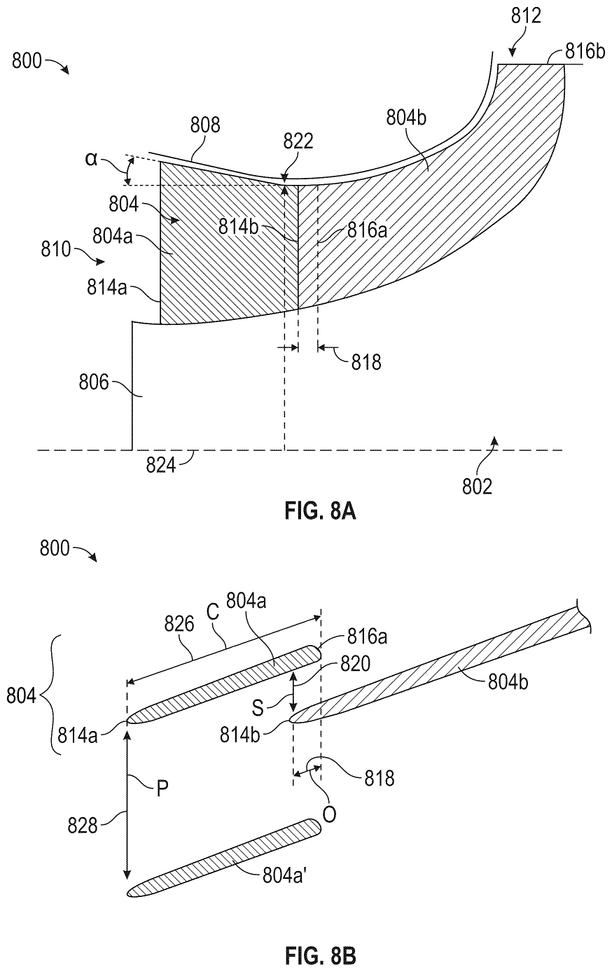

Turning now to FIGS. 8A-8B, schematic illustrations of a portion of an impeller assembly 800 in accordance with an embodiment of the present disclosure are shown. The impeller assembly 800 may be similar to that shown and described. In this illustrative configuration, the impeller assembly 800 includes a rotating component 802 having a number of split impeller blades 804 (divided into impeller blade sections 804a, 804b) extending from a hub 806. The rotating component 802 is arranged within a shroud 808 (e.g., a split shroud as shown and described above) such that the impeller blades 804 may be rotated relative to the shroud 808, as shown and described above. The shroud 808 is supported within a shroud support (not shown), as described above. The impeller assembly 800 defines a flow path from an impeller inlet 810 to an impeller outlet 812. A first impeller blade section 804a includes a respective leading edge 814a at the impeller inlet 810 and a respective trailing edge 816a at a position between the impeller inlet 810 and the impeller outlet 812. A second impeller blade section 804b includes a respective leading edge 814b which is located at a position between the impeller inlet 810 and the impeller outlet 812, and a respective trailing edge 816b at the impeller outlet 812.

Unlike the split impeller blade shown in FIGS. 5A-5B, the split impeller blade 804 of this embodiment includes an axial spacing region 818 (O) defined by the axial distance between the trailing edge 816a of the first impeller blade section 804a and the leading edge 814b of the second impeller blade section 804b. The split impeller blades 804 are separated or divided in the axial direction into a first or forward impeller blade section 804a and a second or aft impeller blade section 804b. Each of the impeller blade sections 804a, 804b are individual airfoil structures, that extend axially from the respective leading edges 814a, 814b to the respective trailing edges 816a, 816b. The impeller blade sections 804a, 804b may be arranged as substantially continuous fluid flow structure, with a separation gap 820 (S) in the circumferential direction (about the rotating component 802).

The split impeller blade 804 is arranged relative to the shroud 808, with a tapering contour or geometry that includes a blade inflection point 822, similar to that shown and described above. In this split impeller blade configuration, the blade inflection point 822 is defined on the first (or forward) impeller blade section 804a. That is, the first impeller blade section 804a includes the blade inflection point 822, proximate the trailing edge 816a thereof. As such, the first impeller blade section 804a extends in an aft direction from the leading edge 814a and tapers radially inward from the leading edge 814a to the blade inflection point 822, and then either extends substantially parallel with an engine axis 824 or extends radially outward from the blade inflection point 822 to the trailing edge 816a of the first impeller blade section 804a. The second impeller blade section 804b is defined with a leading edge 814b that is axially forward of the trailing edge 816a of the first impeller blade section 804a, resulting in the axial spacing region 818. The second impeller blade section 804b is offset from the first impeller blade section 804a by the separation gap 820 in the circumferential direction.

As shown in FIG. 8B, the first impeller blade section 804a has a chord length 826 (C) and is separated from an adjacent another first impeller blade section 804a′ by a blade spacing 828 (P). In accordance with some embodiments of the present disclosure, the impeller assembly 800 may be defined based on the following relationships:

$$0.01 < \frac{S}{P} < 0.25 and - 0.25 < \frac{O}{C} < 0.25 .$$

Accordingly, based on the indicated relationships, the second impeller blade section 804b is located closer to the first impeller blade section 804a than to the adjacent first impeller blade section 804a′, with the separation gap 820 (S) being at most 25% of the total blade spacing 828 (P). It will be appreciated that the separation gap 820 (S) may less than 50% of the total blade spacing 828, such that sections of the split impeller blade are associated with each other by proximity.

In accordance with some embodiments, the axial spacing region 818 may be defined by a positive value, indicating a length of overlap in the axial direction (e.g., as shown in FIGS. 8A-8B). However, in other embodiments, the axial spacing region 818 may be defined by a negative value indicating an axial gap or space between the trailing edge 816a of the first impeller blade section 804a and the leading edge 814b of the second impeller blade section 804b. Based on the indicated relationships, in some embodiments, the amount of axial overlap between the first and second impeller blade sections 804a, 804b may be 25% of the chord length 826 (C) of the first impeller blade section 804a. Further, at the opposite end, the size of the axial gap or spacing from the trailing edge 816a of the first impeller blade section 804a to the leading edge 814b of the second impeller blade section 804b may be up to 25% of the chord length 826 (C) of the first impeller blade section 804a.

It will be appreciated that the impeller blade configurations shown and described in FIGS. 7 and 8A-8B may be used with a split shroud, such as shown and described above. In some embodiments, the angle α of the tapered portion of the impeller blades may be the same as the angle β of tapering of the impeller shroud. This correspondence of the angles α and β provides for a continuous flow path through the impeller assembly, minimizing gaps between the blade tips and the inner surface of the shroud.

Advantageously, embodiments of the present disclosure are directed to improved impeller blade configurations that may improve engine performance and/or efficiency. The impeller blade configurations of embodiments of the present disclosure include a blade inflection point such that an impeller may have an increased inlet size to allow for increased massflow through the impeller assembly. The impeller blades of the present disclosure include such blade inflection point to accommodate an increased inlet area. The impeller blades include a blade tip that tapers radially inward, relative to an engine axis, from a leading edge to the blade inflection point. In some embodiments, the impeller blades may be split impeller blades. In some such embodiments, the split impeller blade may be separated by a gap that may have a stator structure disposed therein. In other such embodiments, the split impeller blade may include two impeller blade sections that are spaced apart in a circumferential direction and have a separation between the trailing edge of a forward impeller blade section and a leading edge of an aft impeller blade section. In some embodiment, the separation of the trailing and leading edges may result in a portion of axial overlap of the two sections. In other such embodiments, an axial gap may be present between the trailing edge of the forward impeller blade section and the leading edge of the aft impeller blade section.

In accordance with some non-limiting examples of the present disclosure, the split impeller blades (e.g., FIGS. 5A-5B, 8A-8B) may provide additional advantages related to the dual blade configuration. For example, by having impeller blades with two sections, the use of different materials may be applied for the forward and aft sections of the impeller blades. Such material modifications can result in cost and weight savings. Furthermore, the positive and negative overlapping design (e.g., FIGS. 8A-8B) offers additional flexibility to optimize the workload distribution between the first and second blade sections. That is, the spacing between the blade sections allows for tailoring the blade sections, blade profiles, blade materials, and the like to achieve a desired flow compression and turning as the flow is passed through the impeller.

As used herein, the terms “about” and “substantially” are intended to include the degree of error associated with measurement of the particular quantity based upon the equipment available at the time of filing the application. For example, these terms may include a range of ±8%, or 5%, or 2% of a given value or other percentage change as will be appreciated by those of skill in the art for the particular measurement and/or dimensions referred to herein. Further, the terms “about” and “substantially”, when associated with non-numerical limits, are intended to include degrees of errors and/or minor variations as would be apparent to those of skill in the art when considering such concepts (e.g., shapes, relative arrangements, etc.).

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. It should be appreciated that relative positional terms such as “forward,” “aft,” “upper,” “lower,” “above,” “below,” “radial,” “axial,” “circumferential,” and the like are with reference to normal operational attitude and should not be considered otherwise limiting.

While the present disclosure has been described with reference to an illustrative embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An impeller assembly for a gas turbine engine comprising:
a hub configured to be rotated about an engine axis;
a plurality of impeller blades extending radially outward from the hub, wherein each impeller blade comprises a leading edge, a trailing edge, a blade tip, and a blade inflection point defined on the blade tip between the leading edge and the trailing edge;
wherein each impeller blade comprises a radially inward tapering portion that extends from the leading edge of the respective impeller blade to the blade inflection point, wherein the radially inward direction is toward the engine axis, and
a radially outward tapering portion that extends from the inflection point to a trailing edge of the respective impeller blade, wherein the radially outward direction is away from the engine axis.

2. The impeller assembly of claim 1, wherein the radially outward tapering portion extends axially forward from the blade inflection point at an angle relative to the engine axis.

3. The impeller assembly of claim 2, wherein the angle is between 1° and 30°.

4. The impeller assembly of claim 1, wherein each impeller blade is defined by the radially inward tapering portion having an axial length Lᵢ defined from the leading edge to the blade inflection point along the blade tip and the blade tip has a blade axial length L_{b} from the leading edge to the trailing edge, and wherein
$$0.05 \leq \frac{{L}_{i}}{{L}_{b}} \leq 0.4 .$$

5. The impeller assembly of claim 1, wherein the hub and plurality of impeller blades define a rotating component that is configured to compress and turn a flow passing therethrough from an axial direction at an inlet to the rotating component to a radial direction at an outlet of the rotating component.

6. The impeller assembly of claim 1, wherein a radial position of the leading edge of the blade tip is at a radial position greater than the blade inflection point.

7. The impeller assembly of claim 1, wherein each impeller blades is a split impeller blade comprising at least a first impeller blade section and a second impeller blade section.

8. The impeller assembly of claim 7, further comprising a stator assembly positioned axially between the first impeller blade section and the second impeller blade section.

9. The impeller assembly of claim 8, wherein the inflection point is defined at an axial position aligned with the stator assembly.

10. The impeller assembly of claim 7, wherein the first impeller blade section and the second impeller blade section are arranged an axial spacing region defined between a trailing edge of the first impeller blade section and a leading edge of the second impeller blade section.

11. The impeller assembly of claim 10, wherein the axial spacing region is defined by a negative value such that the trailing edge of the first impeller blade section is axially aft of the leading edge of the second impeller blade section and defining a section of axial overlap of the first and second impeller blade sections.

12. The impeller assembly of claim 10, wherein the axial spacing region is defined by a positive value such that the trailing edge of the first impeller blade section is axially forward of the leading edge of the second impeller blade section and defining an axial gap between the first impeller blade section and the second impeller blade section.

13. The impeller assembly of claim 10, wherein the first impeller blade section has a chord length (C) and the axial spacing region has a length (O), wherein the impeller assembly is defined by:
$$- 0.25 < \frac{O}{C} < 0.25 .$$

14. The impeller assembly of claim 10, wherein each first impeller blade section of the plurality of impeller blades is separated from adjacent first impeller blade section in a circumferential direction by a blade spacing (P) and the first impeller blade section is spaced from the second impeller blade section in the circumferential direction by a separation gap(S), wherein the impeller assembly is defined by:
$$0.01 < \frac{S}{P} < 0.25 .$$

15. An impeller assembly for a gas turbine engine comprising:
a rotating component comprising a plurality of impeller blades extending radially outward from a hub, wherein an axis is defined through the hub, wherein each impeller blade comprises a leading edge, a trailing edge, a blade tip, and a blade inflection point defined on the blade tip between the leading edge and the training edge,
wherein each impeller blade comprises a radially inward tapering portion that extends from the leading edge of the respective impeller blade to the blade inflection point, wherein the radially inward direction is toward the engine axis, and a radially outward tapering portion that extends from the inflection point to a trailing edge of the respective impeller blade, wherein the radially outward direction is away from the engine axis; and
a split shroud arranged about the rotating component and defining a flow path between an external surface of the hub and an internal surface of the split shroud, wherein the impeller blades are configured to be rotationally driven relative to the split shroud, wherein the split shroud comprises:
a first shroud element and a second shroud element configured to fixedly attach to the first shroud element, wherein each of the first shroud element and the second shroud element comprise:
a radially inward tapering portion that extends from a shroud leading edge of the respective shroud element to an inflection point, wherein the radially inward direction is toward the axis, and
a radially outward tapering portion that extends from the inflection point to a shroud aft edge, wherein the radially outward direction is away from the axis.

16. The impeller assembly of claim 15, further comprising an exducer shroud arranged aft of the split shroud, wherein a bleed slot is defined between a forward edge of the exducer shroud and the shroud aft edge.

17. The impeller assembly of claim 15, wherein each impeller blades is a split impeller blade comprising at least a first impeller blade section and a second impeller blade section.

18. The impeller assembly of claim 17, further comprising a stator assembly positioned axially between the first impeller blade section and the second impeller blade section.

19. The impeller assembly of claim 18, wherein the stator assembly is attached to the split shroud.

20. The impeller assembly of claim 15, further comprising a shroud support positioned about the split shroud and configured to secure the split shroud in place and to define a bleed air cavity between surfaces of the split shroud and the shroud support.
